(19) United States
(12) Patent Application Publication
(10) Pub. No.: US 2025/0217916 A1
(43) Pub. Date: Jul. 3, 2025

(54) HIVE-BASED CARPOOL METHODS AND SYSTEMS

(71) Applicant: MollJenn LLC, Great Neck, NY (US)

(72) Inventor: Molly Goldberg, Great Neck, NY (US)

(21) Appl. No.: 19/005,026

(22) Filed: Dec. 30, 2024

Related U.S. Application Data
(60) Provisional application No. 63/616,246, filed on Dec. 29, 2023.

(51) Int. Cl. G06Q 50/47

(52) U.S. Cl. CPC G06Q 50/47

(57) ABSTRACT

A method for managing a hive-based carpool system may comprise establishing a plurality of households and a hive representing a communication channel for a group of users. The hive may include at least one ride recipient user and all ride provider users in the same household. The method may involve affiliating ride provider users with ride recipient users, receiving a ride request from a user in the hive, transmitting the request to authorized drivers, receiving an acceptance, tracking the driver's location during the ride, and updating ride status in real-time for hive members. The communication channel may enable real-time chat functionality and restrict membership to individuals authorized to provide rides to ride recipients.

### RELATED APPLICATION

Under provisions of 35 U.S.C. § 119(e), the Applicant claims the benefit of U.S. Provisional Application No. 63/616,246 filed on Dec. 29, 2023, which is incorporated herein by reference.

It is intended that each of the referenced applications may be applicable to the concepts and embodiments disclosed herein, even if such concepts and embodiments are disclosed in the referenced applications with different limitations and configurations and described using different examples and terminology.

### FIELD OF DISCLOSURE

The present disclosure generally relates to the field of transportation and ridesharing services. More specifically, it pertains to computer-implemented systems and methods for organizing and managing carpool rides, particularly focused on facilitating safe transportation arrangements for minors by connecting them with validated adult drivers through a controlled communication channel.

### BACKGROUND

In some situations, coordinating transportation for minors can be challenging and time-consuming for parents and guardians. For example, arranging rides for children to attend school, extracurricular activities, and/or social events may require extensive communication and scheduling among multiple parties. Thus, the conventional strategy is to rely on phone calls, text messages, or email chains to organize carpools and rides. This often causes problems because the conventional strategy does not provide a centralized system for efficiently managing ride requests, driver assignments, and real-time tracking. For example, miscommunication about pickup times and/or locations may occur, and parents may lack visibility into their child's transportation status.

Existing ridesharing platforms may not be suitable for transporting minors due to safety concerns. These platforms typically allow any registered driver to accept ride requests, which may not provide adequate vetting or restrictions for transporting children. Additionally, conventional carpooling methods for families and communities may lack integrated features for ride requests, driver assignments, and location tracking.

Thus, there is a need for a specialized system that facilitates safe and efficient transportation coordination for minors within a trusted network of adults. Such a system may need to balance the convenience of on-demand ride requests with appropriate safety measures and parental oversight. Implementing technical solutions to restrict communication channels and ride provision to only authorized adults affiliated with specific groups of minors may present challenges.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

In some embodiments, a method for managing a hive-based carpool system may comprise establishing, by a server, a plurality of households. Each household may comprise at least one ride provider user and at least one ride recipient user. The method may further comprise establishing, by the server, a hive. Each hive may represent a communication channel for a group of users. Each group of users may comprise at least one ride recipient user, and all ride provider users in the same household as the at least one ride recipient user.

The method may include validating an affiliation of each ride provider user in the hive with at least one ride recipient user in the hive. The method may also include validating credentials of each ride provider user within the hive as an authorized driver.

The method may further comprise receiving, from a ride recipient user of the group of users in the hive, a ride request. The ride request may comprise a pickup location, a drop-off location, and a time. The method may include transmitting the ride request to authorized drivers from among the ride provider users in the hive.

The method may comprise receiving an acceptance of the ride request from a particular authorized driver. The method may also include tracking location of the particular authorized driver during provision of the ride. The method may further comprise updating ride status in real-time for at least one other member of the hive.

In other embodiments, a system for facilitating hive-based carpools may comprise a database storing user profiles categorized as ride recipient users or ride provider users. The system may include a hive management module configured to create a plurality of households. Each household may comprise at least one ride provider user and at least one ride recipient user. The hive management module may be further configured to create a hive representing a communication channel for a group of users. The group may comprise at least one ride recipient user, and all ride provider users in the same household as the at least one ride recipient user. The hive management module may also be configured to control membership in the hive based on user category and affiliations.

The system may include a ride request module configured to receive a ride request from a ride recipient user in the hive, and transmit the ride request to one or more validated ride provider users in the hive. The system may further comprise a tracking module configured to monitor real-time location of vehicles providing rides. The system may also include a notification module configured to provide ride status updates to one or more members of a hive.

In still further embodiments, a non-transitory computer-readable medium may store instructions that, when executed by a processor, cause the processor to perform operations. The operations may comprise establishing, by a server, a plurality of households. Each household may comprise at least one ride provider user and at least one ride recipient user. The operations may further comprise establishing, by the server, a hive. Each hive may represent a communication channel for a group of users. Each group of users may comprise at least one ride recipient user, and all ride provider users in the same household as the at least one ride recipient user.

The operations may include validating an affiliation of each ride provider user in the hive with at least one ride recipient user in the hive. The operations may also include validating credentials of each ride provider user within the hive as an authorized driver.

The operations may further comprise receiving, from a ride recipient user in the hive, a ride request. The ride request may comprise a pickup location, a drop-off location, and a time. The operations may include transmitting the ride request to authorized drivers from among the ride provider users in the hive.

The operations may comprise receiving an acceptance of the ride request from a particular authorized driver. The operations may also include tracking location of the particular authorized driver during provision of the ride. The operations may further comprise updating ride status in real-time for at least one other member of the hive.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of an operating environment consistent with the present disclosure;

FIG. 2 is a flow chart of a method for providing hive-based carpool systems and methods; and

FIG. 3 is a block diagram of a system including a computing device for performing the method of FIG. 2.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely to provide a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such a term to mean based on the contextual use of the term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

The present disclosure includes many aspects and features. Moreover, while many aspects and features relate to, and are described in, the context of a carpool platform, embodiments of the present disclosure are not limited to use only in this context.

### I. Platform Overview

This overview is provided to introduce a selection of concepts in a simplified form that are further described below. This overview is not intended to identify key features or essential features of the claimed subject matter. Nor is this overview intended to be used to limit the claimed subject matter's scope.

The carpool platform may allow children or minors to request rides from a trusted group of adults, such as (but not limited to) family members, guardians, family friends, and/or the like. The platform aims to provide a safe and controlled environment for children to arrange carpools with trusted adults, while giving parents oversight and coordination abilities. It combines aspects of social networking, ridesharing, and parental controls into a specialized carpool system for families and trusted groups.

A communication channel or “hive” may connect a group of one or more children/minors with a group of one or more trusted adults. Driving credentials for each of the trusted adults may be verified. In embodiments, the system may restrict hive membership such that no one outside of the group of trusted adults affiliated with at least one of the minors in the group may join.

The minors may request rides through this communication channel. When a minor requests a ride, the ride request may be transmitted to all adults in the hive that are authorized to drive the requesting minor.

The platform may include an interface that allows the adults to discuss, claim, and coordinate ride requests. The platform may provide messaging capabilities within the channel for all users.

Real-time tracking and monitoring may be used to track children and/or drivers as a ride is in progress. This helps to ensure that children are at appointed pickup spots, and gives the driver insight if a child is not at the appointed location it also allows other adults in the group to track the ride.

In embodiments, the platform may be compliant with various privacy regulations, including (but not limited to) the Children's Online Privacy Protection Act (COPPA), Compliance may include posting a privacy policy and receiving verifiable parental consent before collecting personal information from children under 13. The platform may provide parents with direct notice of information practices and disclose any information collected that relates to the children to those children's parents. Children may have the right to revoke consent and have their information deleted. The platform may limit the collection of personal information collected from children, and may protect the confidentiality, security, and integrity of any personal information collected from children.

In some embodiments, the carpool platform may include integration with rideshare technology for route optimization, mapping, real-time tracking of household members (e.g., minors), etc.

Embodiments of the present disclosure may comprise methods, systems, and a computer readable medium comprising, but not limited to, at least one of the following:
A. A User Profiles Datastore
B. A Hive Management Module
C. A Ride Request Module
D. A Tracking Module
E. A Notification Module

In some embodiments, the present disclosure may provide an additional set of modules for further facilitating the software and hardware platform. The additional set of modules may comprise, but not be limited to:
E. A Rideshare Integration Module
F. A Communication Module

Details with regard to each module are provided below. Although modules are disclosed with specific functionality, it should be understood that functionality may be shared between modules, with some functions split between modules, while other functions duplicated by the modules. Furthermore, the name of each module should not be construed as limiting upon the functionality of the module. Moreover, each component disclosed within each module can be considered independently, without the context of the other components within the same module or different modules. Each component may contain functionality defined in other portions of this specification. Each component disclosed for one module may be mixed with the functionality of other modules. In the present disclosure, each component can be claimed on its own and/or interchangeably with other components of other modules.

The following depicts an example of a method of a plurality of methods that may be performed by at least one of the aforementioned modules, or components thereof. Various hardware components may be used at the various stages of the operations disclosed with reference to each module. For example, although methods may be described to be performed by a single computing device, it should be understood that, in some embodiments, different operations may be performed by different networked elements in operative communication with the computing device. For example, at least one computing device 300 may be employed in the performance of some or all of the stages disclosed with regard to the methods. Similarly, an apparatus may be employed in the performance of some or all of the stages of the methods. As such, the apparatus may comprise at least those architectural components as found in computing device 300.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in orders that differ from the ones disclosed below. Moreover, various stages may be added or removed without altering or departing from the fundamental scope of the depicted methods and systems disclosed herein.

Consistent with embodiments of the present disclosure, a method may be performed by at least one of the modules disclosed herein. The method may be embodied as, for example, but not limited to, computer instructions which, when executed, perform the method. The method may comprise the following stages:
establishing, by a server, a hive, wherein each hive represents a communication channel for a group of users, wherein each group of users comprises one or more ride recipient users and one or more ride provider users;
validating an affiliation each ride provider user in the hive with at least one ride recipient user in the hive;
receiving, from a ride recipient user in the hive, a ride request, wherein the ride request comprises a pickup location, a drop-off location, and a time;
transmitting the ride request to authorized drivers from among the ride provider users in the hive;
receiving an acceptance of the ride request from a particular authorized driver;
tracking location of the particular authorized driver during provision of the ride; and
updating ride status in real-time for at least one other member of the hive.

Although the aforementioned method has been described to be performed by the platform 100, it should be understood that computing device 300 may be used to perform the various stages of the method. Furthermore, in some embodiments, different operations may be performed by different networked elements in operative communication with computing device 300. For example, a plurality of computing devices may be employed in the performance of some or all of the stages in the aforementioned method. Moreover, a plurality of computing devices may be configured much like a single computing device 300. Similarly, an apparatus may be employed in the performance of some or all stages in the method. The apparatus may also be configured much like computing device 300.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. Platform Configuration

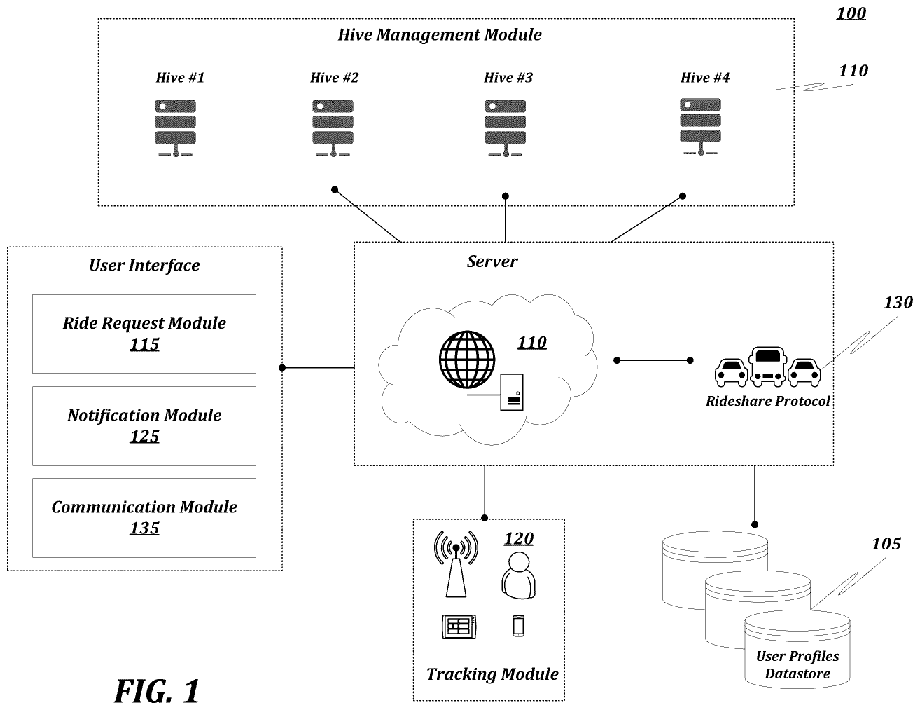

FIG. 1 illustrates one possible operating environment through which a platform consistent with embodiments of the present disclosure may be provided. By way of non-limiting example, a carpool platform 100 may be hosted on, for example, a cloud computing service. In some embodiments, the platform 100 may be hosted on a computing device 300. A user may access platform 100 through a software application and/or hardware device. The software application may be embodied as, for example, but not be limited to, a website, a web application, a desktop application, and a mobile application compatible with the computing device 300.

Accordingly, embodiments of the present disclosure provide a software and hardware platform comprised of a distributed set of computing elements, including, but not limited to:

### A. A User Profile Datastore

In embodiments, the platform 100 may include a user profile datastore 105. The user profile datastore 105 may comprise hardware and/or software configured to store and/or maintain a database or other data storage structure for storing and managing user profile information for users of the hive-based carpool platform 100.

The datastore 105 may store, for each user of the platform 100, user information such as (but not limited to) username, contact details, profile photo, and/or the like. The datastore 105 may categorize the users into different category types, such as ride recipient users (e.g., minors, young adults, disabled persons, elderly persons, and/or otherwise non-driving users) and ride provider users (e.g., parents, family members, guardians, other trusted caretakers, and/or other designated ride providers). While two category types are used here as an example, those of skill in the art will recognize that more, fewer, and/or different category types may be used, and that each user may potentially be assigned to more than one category. Additionally, applicant notes that, while the user categories described herein include “ride provider” and “ride recipient”, there need not be a ride provided. Rather, the categories may be, for example, “task performer” and “task requirer”, whereby a task requirer user asks for another user (e.g., a task performer user) to assist with or perform a task for the task requirer, and/or a task performer user offers to perform tasks(s) for other users (e.g., task requirers).

In embodiments, the user profile datastore 105 may flag profiles created for minors under the age of 13 to help ensure compliance with increased privacy regulations for minor (e.g., COPPA).

The datastore 105 may maintain affiliations between users. In particular, the datastore may note affiliations between ride recipient users and ride provider users, such as guardianship relationships (e.g., parent-child relationships, familial relationships, other guardianship relationships, etc.). In some embodiments, the datastore 105 may track one or more hives/communication channels to which each user belongs.

In embodiments, the datastore 105 may form “households” that represent a plurality of users. Each household may include one or more ride recipient users and one or more ride provider users. As one non-limiting example, a household may include two parents and one or more children associated with those parents. While the term “household” is used to describe the collection of users, those of skill in the art will recognize that the users need not live at a single residential address or have a particular familial (e.g., parent-child) relationship; rather the “household” represents any group of affiliated individuals (e.g., families, co-workers, roommates, organizations, and/or any other cohorts of affiliated people.

The data store may also store credentials and verification information for users. As a specific example, the datastore 105 may include drivers license information for one or more (e.g., each) ride provider user. The drivers license information may include information such as, but not limited to, an affirmation that the user has a valid drivers license. In some embodiments, the system may optionally store a drivers license number, an issuing state, an expiration date, and/or a photograph of the drivers license. While the drivers license is used as a specific example, those of skill in the art will recognize the more and/or different credentials (e.g., confirmation of automobile insurance, identification cards, professional certifications or licenses, etc.) may be retained in the datastore 105. In some embodiments, the datastore 105 may be integrated with one or more external identity/authentication systems to validate the stored credential information.

In some embodiments the datastore 105 may store user preferences, settings, and activity history related to the carpool system. The datastore 105 may also Allowing users to update and manage their own profile information as needed (e.g., so that profile details remain current and accurate).

The user profile datastore may be implemented using database technologies such as (but not limited to) relational databases or NoSQL databases. The datastore 105 may include appropriate data models and schemas to represent the user profile information efficiently. The datastore 105 may utilize caching, replication, and/or other techniques to help ensure high performance and availability.

### B. A Hive Management Module

In embodiments, the platform 100 may include a hive management module 110. The hive management module 110 may comprise hardware and/or software configured to manage the creation, modification, and/or deletion of hives within the platform 100.

The hive management module 110 may be configured to create a new hive in response to a request from a user. The request may be received from either a ride recipient user or a ride provider user. When creating a new hive, the hive management module 110 may assign the requesting user as the initial member and administrator of the hive.

In some embodiments, the hive management module 110 may automatically add affiliated users to a newly created hive. For example, if a minor creates a new hive (e.g., as a ride recipient user), the module 110 may automatically add or invite the affiliated guardians and/or other household members to join the hive (e.g., as ride provider users and/or ride recipient users). Similarly, if a minor creates a new hive, the module 110 may automatically add the minor's affiliated guardians. In some embodiments, (e.g., where the ride recipient user is not a minor), when the ride recipient user creates a new hive, the module 110 may automatically invite one or more household members affiliated with the ride recipient user.

The hive management module 110 may implement one or more rules governing which users can be added to a hive. In some embodiments, the module 110 may restrict ride provider users from adding ride recipient users to a hive unless an affiliation between the users has been validated. Additionally or alternatively, when a ride recipient user is added to a hive (particularly by an unaffiliated ride recipient user), the hive management module may automatically add any ride provider users associated with the ride recipient user. As a particular example, where a minor user adds another minor use (e.g., a friend, teammate, etc.), the hive management module 110 may automatically add the new minor user's parents or guardians. In this way, the number of potential ride providers in the hive may grow and all minors' guardians may be kept abreast of trips the minors are taking.

The hive management module 110 may provide functionality for hive members to invite additional users to join the hive. When an invitation is sent, the module 110 may verify that the invited user meets the criteria for joining the hive before allowing them to be added as a member.

In some embodiments, the hive management module 110 may maintain different membership levels or roles within a hive. For example, there may be administrators who can modify hive settings, regular members who can participate in hive activities, and/or limited members with restricted access. The module 110 may enforce permissions based on these roles.

The hive management module 110 may provide interfaces for viewing and managing hive membership. This may include displaying lists of current members, pending invitations, and options to remove members or change member roles. The module 110 may also track statistics on hive membership and activity levels.

The hive management module 110 may create a virtual address book associated with the hive. The address book may include addresses associated with each household in the hive (e.g. for pick-up/drop-off locations), phone numbers for hive members (e.g., to help reach a hive member running late for a pick-up), and/or any other address or contact information that may be useful (e.g., addresses of pick-up and/or drop-off locations used in the past). In some embodiments, addresses may automatically be added to the address book as they are selected for pick-up or drop-off locations.

In some embodiments, the hive management module 110 may allow hives to be organized hierarchically. For example, there may be sub-hives within a larger hive structure. The module 110 may manage the relationships between parent and child hives, including inheritance of members and settings.

The hive management module 110 may implement privacy controls to restrict visibility of hive information. The module 110 may enforce these privacy settings when displaying hive data.

In some embodiments, the hive management module 110 may provide functionality for archiving or deleting inactive hives. The module 110 may optionally track hive activity levels and prompt administrators to archive hives that have been dormant for a specified period of time. Archived hives may be easily reactivated if needed.

The hive management module 110 may interface with other modules of the platform 100 to enable hive-specific functionality. For example, the module 110 may work with the messaging module to create hive-specific chat channels. It may also coordinate with the ride request module to enable ride sharing within a hive context.

### C. A Ride Request Module

In embodiments, the platform 100 may include a ride request module 115. The ride request module 115 may comprise hardware and/or software configured to facilitate the submission and processing of ride requests within the hive-based carpool system.

The ride request module 115 may be configured to receive ride requests from one or more users within a hive. For example, ride requests may be received from ride recipient users. In some embodiments, the platform 100 may further facilitate ride requests from ride provider users. A ride request may include information such as (but not limited to) a pickup location, a drop-off location, a requested pickup time and/or drop-off time, and any additional notes or requirements for the ride. In some embodiments, the ride request module 115 may provide a user interface, such as a mobile app interface, through which ride recipient users can easily input and submit ride request details.

In various embodiments, the platform may be configured to receive ride requests from different types of ride recipient users within a hive. For example, in addition to minor users, the ride recipient user group may optionally include other users such as (but not limited to) young adults, elderly individuals, or users with special needs who require supervised transportation. The system may allow any user (e.g., a ride recipient user of a ride provider user) to submit ride requests through the communications channel. For instance, a college student who is a member of a hive may submit a ride request for transportation to a campus event. The request may include details such as pickup location, drop-off location, time, and any special requirements. Similarly, an elderly user who is part of a family hive may request a ride to a medical appointment. As yet another example, a parent may submit a ride request on behalf of their child (e.g., if the parent realizes they will not be able to bring the child to soccer practice due to a scheduling conflict). The platform may process these requests in a manner similar to those from minor users, while potentially applying different validation or authorization rules based on the specific user type.

In some implementations, the system may allow customization of ride request parameters based on user type. For example, ride requests from elderly users may automatically include options for wheelchair accessibility or other mobility accommodations. Requests from college students may allow specification of carpooling preferences with other students. In some embodiments, one or more of the pickup location and the drop-off location may be predetermined locations. For example, a minor may only be able to request rides that end at the minor's home. In some embodiments, one or more of the pickup location and the drop-off location may be selectable from a list. For example, the minor may select from a list of locations that include home, school, or baseball practice. In some embodiments, ride recipient users may be able to search for nearby locations. For example, the nearby locations may include a selection of kid-friendly locations.

Responsive to receiving a ride request, the ride request module 115 may validate the request (e.g., to ensure all required information is provided and/or that the requesting user is authorized to submit requests within that particular hive). In some embodiments, the module 115 may verify whether the requested pickup and drop-off locations fall within approved boundaries for that hive.

After validating a ride request, the ride request module 115 may transmit the request details to one or more authorized drivers (e.g., ride provider users) within the hive. In some embodiments, this may involve sending push notifications and/or in-app alerts to ride provider users who have been validated as approved drivers for that hive. Additionally or alternatively, the module 115 may send notifications via SMS, email, and/or any other means of transmitting electronic notifications. The ride request notification may include at least a portion of the ride request information specified by the requesting user, such as pickup and/or drop-off locations and/or times to allow drivers to quickly assess if they can fulfill the request.

The ride request module 115 may be configured to receive and process responses from drivers. This may include tracking which drivers have viewed the request, which have declined, and which have offered to accept the ride. In some embodiments, the module 115 may implement a first-come-first-served system for ride acceptance. In other embodiments, the module 115 may allow multiple drivers to offer availability and then facilitate a selection process involving the ride requestor, the available drivers, and/or a hive administrator.

Once a driver has been confirmed for a ride request, the ride request module 115 may generate a formal ride assignment and communicate this to relevant parties (e.g., the assigned driver, the ide requestor, and/or the hive administrator). This may include sending confirmations to the requesting user, the assigned driver, and/or other stakeholders such as one or more parents or guardians of the minor requesting the ride.

In some embodiments, the ride request module 115 may include scheduling functionality to allow users to submit ride requests in advance. The module 115 may maintain a database of scheduled future rides and implement a system to begin processing these requests at appropriate times prior to the scheduled pickup.

The ride request module 115 may provide functionality for modifying or canceling existing ride requests. This may include implementing rules around how close to the scheduled pickup time changes or cancellations are allowed, and how to handle scenarios where a driver has already been assigned.

In some implementations, the ride request module 115 may interface with external mapping and/or routing services to provide estimated travel times and suggested routes as part of the ride request and assignment process. This information may be used to help drivers assess their ability to fulfill a request and/or to provide more accurate pickup and drop-off time estimates.

The ride request module 115 may maintain a history of ride requests and their outcomes. This data may be used for reporting purposes, to analyze usage patterns, and/or to optimize future ride matching based on historical trends.

In some embodiments, the ride request module 115 may implement a priority system for ride requests. For example, rides to school or other essential activities may be given higher priority than discretionary trips. The module 115 may factor these priorities into how ride requests are presented to potential drivers.

The ride request module 115 may also include functionality to handle recurring ride requests, such as regular trips to after-school activities. Users may be able to set up recurring requests that are automatically submitted at specified intervals without needing to manually input the details each time.

In some implementations, the ride request module 115 may support multi-stop rides, allowing users to request trips with multiple pickup and/or drop-off points. The module 115 may optimize the routing for these more complex trips and ensure all relevant parties are notified of the full itinerary.

The ride request module 115 may be designed with flexibility to accommodate various hive-specific rules or restrictions. For example, some hives may optionally require parental approval for all ride requests submitted by minors, and/or all ride requests submitted during certain time periods. The module 115 may implement workflows to obtain and track these approvals as part of the request process.

### D. A Tracking Module

In embodiments, the platform 100 may include a tracking module 120. The tracking module 120 may comprise hardware and/or software configured to monitor and provide real-time information for users during carpool rides arranged through the platform 100.

The tracking module may be able to provide ride status updates such as (but not limited to) ride request creation, claiming of the ride by a ride provider user, ending of the ride by a ride provider user, and/or one or more status updates during the ride.

In some embodiments, the tracking module 120 may be configured to receive location data from mobile devices associated with users of the platform 100. For example, the tracking module may receive location information from a mobile device associated with a ride provider (e.g., an assigned driver) and/or one or more ride recipients. In some embodiments, the tracking module 120 may interface with GPS functionality on one or more user devices to obtain precise location coordinates. The tracking module 120 may receive location updates at regular intervals, such as every 30 seconds or every minute, or may receive continuous real-time streaming of location data.

In some embodiments, the tracking module 120 may be configured to display the real-time locations of users on a map interface for one or more ride stakeholders. For example, the location information may be displayed to one or more ride recipients, one or more ride providers, one or more affiliated guardians, and/or the like. The map interface may show the current location of a driver providing a ride, as well as locations of one or more minors who are designated to be passengers in the vehicle during at least a portion of the ride. The map interface may be viewable by members of the hive associated with an active carpool ride.

The tracking module 120 may provide estimated time of arrival (ETA) information for various waypoints during a carpool ride. For example, the tracking module 120 may calculate and display an ETA for the driver to arrive at a pickup location, as well as ETAs for drop-off at one or more destinations. The ETA calculations may take into account factors such as (but not limited to) traffic conditions, route optimization, and/or historical travel time data.

In some embodiments, the tracking module 120 may include geofencing functionality. The tracking module 120 may be configured to create virtual perimeters around designated locations, such as pickup and drop-off points. When a user enters or exits a geofenced area, the tracking module 120 may generate an alert or notification. This may allow the platform 100 to automatically detect when a driver has arrived at a pickup location or when a minor has been dropped off at their destination.

The tracking module 120 may provide route recording capabilities. The module 120 may store a log of the exact route taken during a carpool ride, including timestamps for key events like pickups and drop-offs. This route history may be retained for a configurable time period for safety and accountability purposes.

In some embodiments, the tracking module 120 may include functionality to detect potential safety issues during a ride. For example, the module 120 may be configured to identify if a vehicle deviates significantly from the expected route or makes an unscheduled stop. The tracking module 120 may generate alerts to hive members or platform administrators if such anomalies are detected.

The tracking module 120 may provide an interface for users to manually indicate their status during a ride. For example, a driver may be able to mark that they have picked up or dropped off a specific passenger. Similarly, minor users may have the ability to check in when they have been picked up or have reached their destination safely.

In some embodiments, the tracking module 120 may integrate with other components of the platform 100 to provide additional functionality. For example, the tracking module 120 may work in conjunction with the notification module 125 to automatically send updates to relevant hive members based on the real-time location and status of a carpool ride.

The tracking module 120 may include privacy controls to manage access to location data. In some embodiments, precise location tracking may only be enabled during active carpool rides. The module 120 may also allow users to temporarily pause location sharing if needed for privacy reasons.

In some implementations, the tracking module 120 may provide summary reports and analytics based on historical tracking data. This may include statistics on common routes, average ride durations, frequently visited locations, and other insights that may be useful for optimizing the carpooling experience within a hive.

### E. A Notification Module

In embodiments, the platform 100 may include a notification module 125. The notification module 125 may comprise hardware and/or software configured to generate and/or send various types of notifications to users of the platform 100. In some embodiments, the notification module 125 may interface with other components of the platform 100, such as the tracking module 120, to determine when notifications should be sent.

The notification module 125 may be configured to send notifications through multiple channels. For example, the notification module 125 may send push notifications to mobile devices, SMS text messages, emails, in-app notifications, and/or any other type of electronic notification within the platform 100 interface. The specific notification channels used may be configurable by users.

In some embodiments, the notification module 125 may generate one or more ride status notifications. For example, the notification module 125 may send a notification when a ride request is submitted, when a driver accepts a ride request, when a driver is in route to a pickup location, when a driver arrives at a pickup location, when a ride begins, when a ride ends, and/or when there are any changes or delays to an ongoing ride.

In various embodiments, the platform may provide functionality for updating ride status information to one or more members of the hive beyond just those directly involved in the active carpool ride (e.g., one or more members of a ride recipient's household). This allows for enhanced visibility and coordination among the broader group of affiliated users.

The notification module 125 may be configured to send ride status updates to some or all members of the hive when certain events or milestones occur during an active carpool ride. For example, notifications may be sent when: the ride is initially claimed by a driver; the driver arrives at the pickup location; the rider(s) are picked up; the vehicle departs from the pickup location; the vehicle arrives at the drop-off location; the rider(s) are dropped off; the ride is completed; and/or any other pre-defined notification events.

In some embodiments, hive members may be able to customize which types of notifications they receive about rides they are not directly involved in. For instance, a parent may choose to receive all notifications about rides involving their child, but only start/end notifications for other children in the hive.

The platform may also provide a ride status dashboard or feed visible to hive members, showing real-time information about any active rides within the hive. This may include details such as: driver and/or rider identities, pickup and/or drop-off locations, estimated and/or actual pickup/drop-off times, current vehicle location, ride progress (e.g., “En route to pickup”, “Riders on board”, etc.), and/or the like.

Access to specific ride details may be restricted based on user roles and/or permissions within the hive. For example, parents or guardians may be able to see full details for rides involving their affiliated users, but more limited information for other rides.

In some embodiments, the notification module 125 may allow hive members to communicate with those involved in an active ride. For instance, a parent could send a message to the driver or their child during the ride via the messaging interface. These communications may be logged and associated with the specific ride record. The notification module 125 may be configured to send notifications to different user types based on their role. For example, minor users may receive notifications about ride status, while parent/guardian users may receive both ride status notifications and alerts about their child's activity on the platform 100.

In some embodiments, the notification module 125 may include geofencing capabilities. The notification module 125 may be configured to send notifications when a user enters or exits predefined geographic areas. For example, a notification may be sent to a parent when their child arrives at school or returns home.

The notification module 125 may provide customizable notification preferences. Users may be able to select which types of notifications they wish to receive and/or how they want to receive them. For example, a user may choose to receive ride status updates via push notification but safety alerts via SMS.

In some embodiments, the notification module 125 may generate and/or send safety-related notifications. For example, if the tracking module 120 detects that a ride has deviated significantly from its expected route, the notification module 125 may send an alert to relevant users.

The notification module 125 may be configured to send reminders and prompts to users. For example, the module 125 may send a reminder to a driver shortly before a scheduled pickup time. It may also prompt users to rate or review a completed ride.

In some embodiments, the notification module 125 may include message templating capabilities. This may allow for the efficient generation of notifications with dynamic content based on ride details, user information, and other contextual data.

The notification module 125 may include logging and analytics capabilities. The module 125 may keep a record of notifications sent, including timestamp, recipient, notification type, and delivery status. This data may be used to generate reports on notification activity and effectiveness.

In some embodiments, the notification module 125 may support two-way communication. For example, users may be able to respond to certain notifications with predefined actions or replies. This may allow for quick communication between riders and drivers without leaving the notification interface.

### E. A Rideshare Integration Module

In some embodiments, the platform 100 may optionally include a rideshare integration module 130. The rideshare integration module 130 may comprise hardware and/or software configured to interface with one or more third-party rideshare services. The rideshare integration module 130 may include APIs and protocols to communicate with external rideshare platforms and incorporate their functionality into the hive-based carpool platform 100.

The rideshare integration module 130 may enable features such as ride scheduling, fare estimation, driver matching, and/or route optimization from third-party services to be accessed within the hive communication channels. This integration may allow users to seamlessly request rides through familiar rideshare interfaces while still maintaining the safety controls of the hive system. A unified payment system may provide a single interface for payments across rideshare providers, helping to ensure driver and service compensation.

In some embodiments, the rideshare integration module 130 may map hive ride data to one or more third-party API formats (e.g., to match a data form used by the various rideshare providers) and aggregates options across providers for fare and service comparison. In this way, a user may enter ride information into the platform 100 and compare pricing and service options across multiple rideshare platforms.

In various embodiments, the platform may include (or may interface with) a route optimization module configured to determine efficient routes for rides involving multiple pickup and drop-off locations. The route optimization module may employ various algorithms and methods to calculate optimal or near-optimal routes that minimize total travel time, distance, or other relevant metrics while satisfying the pickup and drop-off requirements for all passengers. As examples, the route optimization module may suggest ride pairings and schedules within hives by analyzing factors like route efficiency and user preferences. This may help to reduce ride length and/or cost while still ensuring all ride recipients reach their destination(s).

The route optimization module may receive as input the current locations of all passengers to be picked up, their respective drop-off locations, and optionally the current location of the driver. Additional inputs may include real-time traffic data, historical traffic patterns, road conditions, and user preferences such as avoiding highways or toll roads.

In some embodiments, the route optimization module may utilize a modified version of the traveling salesman problem (TSP) algorithm to determine an efficient route. The TSP algorithm may be adapted to account for the constraints of pickup locations necessarily preceding their corresponding drop-off locations in the route order.

One possible implementation of the route optimization algorithm may proceed as follows:
1. Identify all pickup and drop-off locations;
2. Create a graph representation with nodes for each location and edges representing travel times between locations;
3. Apply constraints to ensure pickups precede drop-offs for each passenger;
4. Use a heuristic method such as nearest neighbor or insertion heuristics to generate an initial feasible route;
5. Apply local search techniques like 2-opt or 3-opt to improve the initial route; and
6. Optionally, use metaheuristics such as simulated annealing or genetic algorithms to further optimize the route.

The route optimization module may consider various factors when calculating routes. For example, it may prioritize minimizing the total time all passengers spend in the vehicle over minimizing the driver's total trip time. It may also factor in scheduled pickup times, aiming to arrive at each pickup location within an acceptable time window.

In some embodiments, the route optimization module may dynamically update and re-optimize routes in real-time based on changing conditions. For instance, if a new passenger requests a ride that can be accommodated by an in-progress carpool, the module may recalculate the optimal route to include the new pickup and drop-off locations.

The platform may provide an interface for drivers to view and/or interact with the optimized route, including turn-by-turn directions and estimated arrival times for each stop. This interface may be integrated with mapping and navigation services to provide real-time guidance to the driver.

In certain embodiments, the route optimization module may consider the capacity constraints of the vehicle when determining routes. For example, it may ensure that the number of passengers in the vehicle at any given time does not exceed the vehicle's seating capacity. The route optimization module may also take into account user preferences and constraints. For instance, some users may specify a maximum acceptable detour time or distance for their ride. The module may attempt to satisfy these preferences while still optimizing the overall route.

In some implementations, the route optimization module may employ machine learning techniques to improve its performance over time. By analyzing historical ride data, the module may learn patterns and preferences that can be used to generate more efficient routes in future optimizations.

The platform may provide users with estimated pickup and drop-off times based on the optimized route. These estimates may be continuously updated as the ride progresses, taking into account real-time factors such as traffic conditions and actual travel times.

In certain embodiments, the route optimization module may consider environmental factors when calculating routes. For example, it may prioritize routes that minimize fuel consumption or emissions, contributing to more environmentally friendly carpooling.

In some embodiments, the route optimization module may track and show information including time saved by carpooling, gas saved (e.g., in terms of gallons or cost) via carpooling and/or route optimization, environmental impact of carpooling and/or route optimization, and/or any other statistics that help to show the benefits of the carpooling and/or route optimization.

In some embodiments, the rideshare integration module 130 may include a translation layer to map data and functionality between the hive platform and external rideshare services. This may involve converting ride requests, user profiles, and other relevant information into formats compatible with third-party APIs.

The rideshare integration module 130 may be configured to aggregate ride options from multiple rideshare providers. This may allow users to compare fares, estimated arrival times, and other factors across different services before selecting a ride.

In some embodiments, the rideshare integration module 130 may include a ride optimization engine. This engine may analyze factors like route efficiency, driver availability, and user preferences to suggest optimal ride pairings and schedules for carpools within a hive.

The rideshare integration module 130 may provide a unified payment interface that allows users to pay for rides from different services through a single system. This may simplify the payment process for users while still ensuring proper compensation to drivers and rideshare companies.

The rideshare integration module 130 may provide analytics and reporting capabilities to track usage of integrated rideshare services within hives. This data may be used to optimize the integration and inform future platform development.

### F. A Communication Module

In embodiments, the platform 100 may include a communication module 135. The communication module 135 may comprise hardware and/or software configured to enable various forms of communication between users within the hive-based carpool system. In some embodiments, the communication module 135 may provide real-time messaging capabilities between members of a hive. The messaging interface may allow users to send text messages, images, audio clips, and/or other media to individuals or groups within their hive.

In certain implementations, the communication module 135 may support creation of distinct communication channels within a hive. This may allow age-appropriate discussions and coordination to occur. The communication module 135 may provide combined channels visible to all user types within a hive. In some embodiments, the communication module may automatically translate communication to a selected language, allowing for communication across language barriers.

In various embodiments, the platform may optionally provide distinct messaging interfaces for different user types within a hive. Specifically, the communication module 130 may enable various separate messaging channels.

A first messaging interface may be configured for adult users only. This interface enables parents, guardians, and other authorized adult users to discuss ride coordination, schedules, and other logistical matters without involving the minor users. The first messaging interface may include more advanced features like file sharing and calendar integration to help coordinate rides.

A second messaging interface may be configured as a combined channel visible to both minor and adult users. This interface facilitates communication between all members of the hive and may be used for general announcements, ride requests, and group discussions. The combined messaging interface may include features to clearly distinguish between minor and adult users, such as different colored message bubbles or user icons.

The communication module 130 may allow users to easily switch between these interfaces within the same hive. In some embodiments, notifications may be customized for each interface, allowing users to prioritize messages from certain channels.

The distinct messaging interfaces provide several advantages. They allow for age-appropriate communication, enhance privacy, and enable more efficient coordination between different user groups. The separation of messaging channels also adds an extra layer of safety by allowing adult users to monitor and control the flow of information to minor users.

In various embodiments, the hive management module 110 may control access to these different messaging interfaces based on user type and permissions. In some embodiments, users may optionally be able to provide one another with a “hive five” (e.g., a thank you, virtual gifts (e.g., stickers, badges, etc.), and/or real-life gifts (e.g., gift cards) for accepting rides or performing other actions that help the hive.

In some embodiments, the messaging interfaces may include features specifically designed to enhance the carpooling experience. For example, the combined messaging interface may include a ride calendar view, showing all upcoming and past rides for the hive. The adult-only interface may include a driver availability tool, allowing adult users to indicate when they are free to provide rides.

These distinct messaging interfaces, working in concert with the other modules of the platform, provide a comprehensive communication solution tailored to the unique needs of a hive-based carpool system. By offering separate channels for different user types while maintaining a combined space for group interaction, the platform enhances both the safety and efficiency of the carpooling process.

The communication module 135 may integrate with other components of the platform 100 to facilitate ride coordination. For instance, it may allow users to initiate ride requests directly through the messaging interface (e.g., using a natural language interface). The module 135 may then notify relevant hive members about new ride requests.

In some embodiments, the communication module 135 may provide voice and/or video calling capabilities between hive members. This may enable real-time communication for coordinating pickups or addressing any issues during rides.

The communication module 135 may include notification features to alert users about important hive and/or ride-related events. For example, the module 135 may send push notifications when a new ride request is posted, when a driver accepts a ride, and/or when a ride is completed.

In certain implementations, the communication module 135 may provide translation capabilities to facilitate communication between users speaking different languages. This may expand the pool of potential drivers and/or riders who can coordinate through the platform 100.

The communication module 135 may include privacy and security features to protect user data and communications. This may involve end-to-end encryption of messages, ability to set message expiration times, and controls over which hive members can contact each other.

In some embodiments, the communication module 135 may provide an interface for parents/guardians to monitor communications involving their affiliated minors. This may help ensure appropriate use of the platform by younger users.

The communication module 135 may integrate with external messaging platforms in certain implementations. This may allow users to receive notifications and participate in hive communications through familiar messaging apps.

In some embodiments, the communication module 135 may include content moderation features to detect and filter inappropriate content. This may help maintain a safe environment for all users, especially minors.

The communication module 35 may provide archiving capabilities for hive communications. This may allow users to reference past ride coordination details or other important information shared within the hive.

### III. Platform Operation

Embodiments of the present disclosure provide a hardware and software platform operative by a set of methods and computer-readable media comprising instructions configured to operate the aforementioned modules and computing elements in accordance with the methods. The following depicts an example of at least one method of a plurality of methods that may be performed by at least one of the aforementioned modules. Various hardware components may be used at the various stages of operations disclosed with reference to each module.

For example, although methods may be described as being performed by a single computing device, it should be understood that, in some embodiments, different operations may be performed by different networked elements in operative communication with the computing device. For example, at least one computing device 300 may be employed in the performance of some or all of the stages disclosed with regard to the methods. Similarly, an apparatus may be employed in the performance of some or all of the stages of the methods. As such, the apparatus may comprise at least those architectural components found in computing device 300.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones described below. Moreover, various stages may be added or removed from the method without altering or departing from the fundamental scope of the depicted methods and systems disclosed herein.

### A. Master Method

Consistent with embodiments of the present disclosure, a method may be performed by at least one of the aforementioned modules. The method may be embodied as, for example, but not limited to, computer instructions, which, when executed, perform the method.

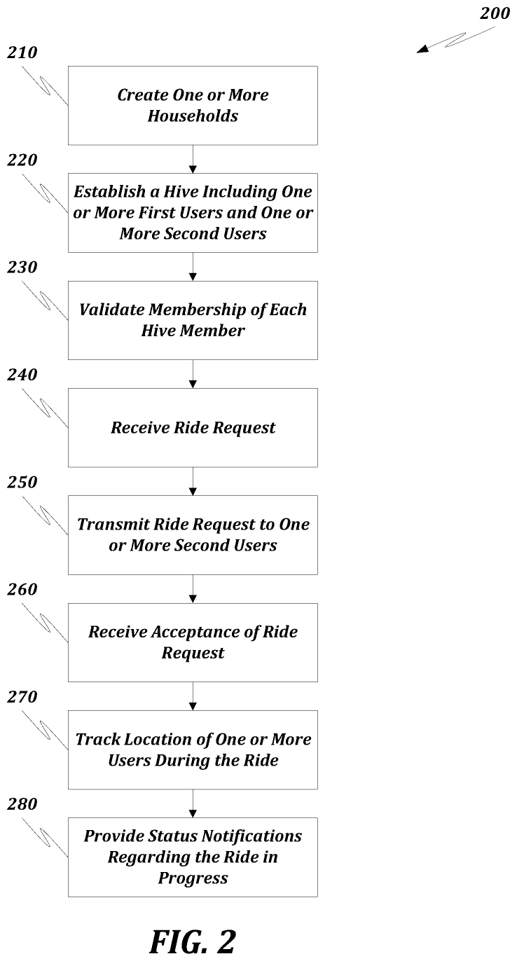

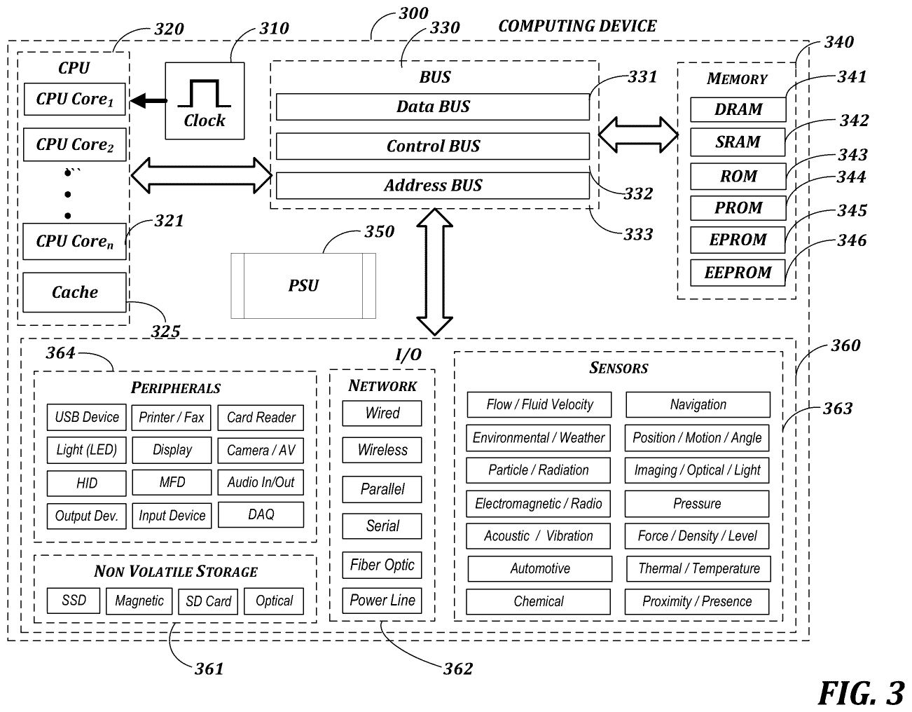

FIG. 2 is a flow chart setting forth the general stages involved in a method 200 consistent with an embodiment of the disclosure for providing carpool platform 100. Method 200 may be implemented using a computing device 300 or any other component associated with platform 100 as described in more detail below with respect to FIG. 3. For illustrative purposes alone, computing device 300 is described as one potential actor in the following stages.

Method 200 may facilitate ride coordination between minors and trusted adults. Beginning at stage 210, a computing device 300 may create one or more “households” or groups of affiliated users. Each household may include one or more ride recipient users and one or more ride provider users.

In stage 220, the computing device 300 may establish a communications channel, or “hive”. The communications channel may be established by either a ride recipient user (e.g., a minor, young adult, elderly person, person with special needs, etc. who may need a ride periodically) or a ride provider user (e.g., a validated parent, family member, or guardian, a trusted driver willing to provide rides, etc.). The hive may serve as the primary interface for coordinating rides and communicating between members.

When establishing a new hive, the computing device 300 may enforce certain restrictions on membership in stage 230. For example, a ride provider user may not be permitted to invite a ride recipient user to join unless the ride provider user has been validated as affiliated with that ride recipient user (e.g., an affiliation may indicate a guardianship and/or familial relationship). However, a second user (e.g., a parent of a first child) may invite another second user (e.g., another parent of the first child or a parent of a second child). In some embodiments, a (minor) ride recipient user may be permitted to invite any other users they choose to invite. As discussed above, when another minor is added to the hive, one or more guardians affiliated with he minor may also be added to the hive.

In some embodiments, when a minor user initiates creation of a hive, one or more (e.g., both) parents/guardians (and/or any other designated members of the minor's household) may be automatically added to the hive. This may help to ensure proper oversight and participation by authorized adults. Moreover, for each minor ride recipient user added to a hive, the hive may automatically invite one or more parent/guardian users associated with the minor user.

In some embodiments, where a parent/guardian (e.g., a ride provider user) initiates creation of a hive, the parent/guardian may add one or more ride recipient users and/or other ride provider users to the hive. Where a ride recipient user is added to the hive, the computing device may ensure that one or more (e.g., all) ride provider users associated with (e.g., in the same household as) the ride recipient user are also added to the hive.

The hive may function as an ongoing chat group with augmented ride coordination capabilities. Members can use the messaging interface to communicate about general topics or specific ride needs. When a ride is requested, the hive becomes active and additional features such as location tracking may be engaged.

In some embodiments, the computing device 300 may further verify credentials of one or more (e.g., each) ride provider user in the hive. The credential verification process may help ensure that only authorized and trusted adults are able to provide rides to minors within the system.

The credential verification may involve multiple steps. In one implementation, when a ride provider user (e.g., an adult) attempts to join a hive, the system may first check if that user has a verified affiliation with at least one first user (e.g., minor) already in the hive. This affiliation may be established previously, for example during user registration, and stored in the user profiles datastore.

The user may be asked to verify that they have a valid drivers license and automobile insurance. The verification may be stored in association with the user's profile. In some implementations, credentials may need to be re-verified periodically, such as annually.

The computing device 300 may receive a ride request at stage 240. To request a ride, a ride recipient user may submit a ride request through the hive interface. The ride request may include details such as pickup location, drop-off location, and desired time. In some embodiments, drop-off locations may require approval by affiliated ride provider users before being accepted. In some embodiments, the process for handling ride requests may include: receiving the initial ride request from a ride recipient user through the communications channel interface, validating the ride request details, including pickup location, drop-off location(s), requested time, and number of riders, and checking the availability and eligibility of ride provider users within the hive to fulfill the ride request.

At stage 250, the computing device may transmit the ride request to one or more eligible ride provider users who are members of that hive. The computing device may notify eligible ride provider user of the ride request through the messaging interface. The ride provider users may discuss and coordinate amongst themselves to determine who will accept responsibility for the ride.

A ride provider user (e.g., a user from among the ride provider users with validated driving credentials) may claim the ride request at stage 260. As non-limiting example, the ride provider user may claim the ride request either through self-selection or delegation by other members. When a ride is claimed, all members of the hive may be notified. The claiming user becomes the designated driver for that ride. The computing device may confirm ride details with the requesting ride recipient user member.

During an active ride, the computing device may track a location of one or more users involved in the rid at stage 270. In various embodiments, the platform may provide functionality for tracking the location of users during an active carpool ride. The tracking module may be configured to monitor the real-time location of the designated driver and/or the ride recipients.

A tracking module may utilize the GPS capabilities of users' mobile devices to obtain location data. In some embodiments, the tracking module may poll the GPS sensors of user devices at regular intervals, such as every 30 seconds, to update location information. Alternatively, the tracking module may receive continuous location updates pushed from user devices.

Location data for the driver and riders may be displayed on an interactive map interface within the platform's mobile application or web interface. The map may show the current position of the vehicle as well as the planned route. Estimated time of arrival (ETA) information may be calculated and displayed based on the vehicle's location and route.

In some embodiments, the tracking module may implement geofencing functionality. Virtual perimeters may be established around key locations such as pickup points, drop-off locations, and route corridors. The tracking module may generate alerts if the vehicle deviates from the expected route or geofenced areas.

The tracking module may record the full route taken during each ride, storing timestamped location data points. This route history may be made available for later review by authorized users such as parents.

Access to real-time location tracking may be restricted based on user roles and permissions within the platform. For example, parents or guardians may be granted full access to track rides of affiliated minors, while other hive members may only see limited location details, or no location details at all.

The location tracking functionality may be integrated with third-party mapping and navigation services to provide enhanced route planning, traffic information, and navigation assistance to drivers.

Users may have options to customize location sharing preferences, such as only sharing location during active rides or setting time limits on location visibility. Privacy controls may allow users to temporarily pause location sharing if needed.

The tracking module may interface with the notification module to provide location-based alerts and status updates to relevant users in stage 280. For instance, notifications may be sent when the vehicle is approaching a pickup or drop-off point.

In some implementations, the tracking module may detect potential safety issues based on location data. For example, unexpected stops, route deviations, or travel to restricted areas may trigger safety alerts to designated contacts.

In some embodiments, rides may be unclaimed even after initial acceptance. The platform may allow manual or automatic completion of rides. For example, a ride may be automatically marked as completed upon detection that the last child has been dropped off at their designated location.

Hives may remain open indefinitely unless manually deleted by members. This allows the communication channel and ride coordination capabilities to be reused for future needs without requiring recreation.

By providing these specialized coordination and safety features, the platform enables efficient carpooling for minors while maintaining appropriate oversight by trusted adults. The curated nature of hive membership and robust tracking features offer advantages over general-purpose ridesharing platforms for this sensitive use case.

### IV. Hardware Architecture

Embodiments of the present disclosure provide a hardware and software platform operative as a distributed system of modules and computing elements.

Platform 100 may be embodied as, for example, but not be limited to, a website, a web application, a desktop application, a backend application, and a mobile application compatible with a computing device 300. The computing device 300 may comprise, but not be limited to, the following:

Mobile computing device, such as, but is not limited to, a laptop, a tablet, a smartphone, a drone, a wearable, an embedded device, a handheld device, an Arduino, an industrial device, or a remotely operable recording device;

A supercomputer, an exascale supercomputer, a mainframe, or a quantum computer;

A minicomputer, wherein the minicomputer computing device comprises, but is not limited to, an IBM AS400/iSeries/System I, A DEC VAX/PDP, an HP3000, a Honeywell-Bull DPS, a Texas Instruments TI-990, or a Wang Laboratories VS Series;

A microcomputer, wherein the microcomputer computing device comprises, but is not limited to, a server, wherein a server may be rack-mounted, a workstation, an industrial device, a raspberry pi, a desktop, or an embedded device;

Platform 100 may be hosted on a centralized server or a cloud computing service. Although method 200 has been described to be performed by a computing device 300, it should be understood that, in some embodiments, different operations may be performed by a plurality of the computing devices 300 in operative communication on at least one network.

Embodiments of the present disclosure may comprise a system having a central processing unit (CPU) 320, a bus 330, a memory unit 340, a power supply unit (PSU) 350, and one or more Input/Output (I/O) units. The CPU 320 coupled to the memory unit 340 and the plurality of I/O units 360 via the bus 330, all of which are powered by the PSU 350. It should be understood that, in some embodiments, each disclosed unit may actually be a plurality of such units for redundancy, high availability, and/or performance purposes. The combination of the presently disclosed units is configured to perform the stages of any method disclosed herein.

FIG. 3 is a block diagram of a system including computing device 300. Consistent with an embodiment of the disclosure, the aforementioned CPU 320, the bus 330, the memory unit 340, a PSU 350, and the plurality of I/O units 360 may be implemented in a computing device, such as computing device 300 of FIG. 3. Any suitable combination of hardware, software, or firmware may be used to implement the aforementioned units. For example, the CPU 320, the bus 330, and the memory unit 340 may be implemented with computing device 300 or any of other computing devices 300, in combination with computing device 300. The aforementioned system, device, and components are examples and other systems, devices, and components may comprise the aforementioned CPU 320, the bus 330, and the memory unit 340, consistent with embodiments of the disclosure.

At least one computing device 300 may be embodied as any of the computing elements illustrated in all of the attached figures, including [list the modules and methods]. A computing device 300 does not need to be electronic, nor even have a CPU 320, nor bus 330, nor memory unit 340. The definition of the computing device 300 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 300, especially if the processing is purposeful.

With reference to FIG. 3, a system consistent with an embodiment of the disclosure may include a computing device, such as computing device 300. In some configurations, the computing device 300 may include at least one clock module 310, at least one CPU 320, at least one bus 330, and at least one memory unit 340, at least one PSU 350, and at least one I/O 360 module, wherein I/O module may be comprised of, but not limited to a non-volatile storage sub-module 361, a communication sub-module 362, a sensors sub-module 363, and a peripherals sub-module 364.

In a system consistent with an embodiment of the disclosure, the computing device 300 may include the clock module 310, known to a person having ordinary skill in the art as a clock generator, which produces clock signals. Clock signals may oscillate between a high state and a low state at a controllable rate and may be used to synchronize or coordinate actions of digital circuits. Most integrated circuits (ICs) of sufficient complexity use a clock signal in order to synchronize different parts of the circuit, cycling at a rate slower than the worst-case internal propagation delays. One well-known example of the aforementioned integrated circuit is the CPU 320, the central component of modern computers, which relies on a clock signal. The clock 310 can comprise a plurality of embodiments, such as, but not limited to, a single-phase clock which transmits all clock signals on effectively 1 wire, a two-phase clock which distributes clock signals on two wires, each with non-overlapping pulses, and a four-phase clock which distributes clock signals on 4 wires.

Many computing devices 300 may use a “clock multiplier” which multiplies a lower frequency external clock to the appropriate clock rate of the CPU 320. This allows the CPU 320 to operate at a much higher frequency than the rest of the computing device 300, which affords performance gains in situations where the CPU 320 does not need to wait on an external factor (like memory 340 or input/output 360). Some embodiments of the clock 310 may include dynamic frequency change, where the time between clock edges can vary widely from one edge to the next and back again.

In a system consistent with an embodiment of the disclosure, the computing device 300 may include the CPU 320 comprising at least one CPU Core 321. In other embodiments, the CPU 320 may include a plurality of identical CPU cores 321, such as, but not limited to, homogeneous multi-core systems. It is also possible for the plurality of CPU cores 321 to comprise different CPU cores 321, such as, but not limited to, heterogeneous multi-core systems, big.LITTLE systems and some AMD accelerated processing units (APU). The CPU 320 reads and executes program instructions which may be used across many application domains, for example, but not limited to, general purpose computing, embedded computing, network computing, digital signal processing (DSP), and graphics processing (GPU). The CPU 320 may run multiple instructions on separate CPU cores 321 simultaneously. The CPU 320 may be integrated into at least one of a single integrated circuit die, and multiple dies in a single chip package. The single integrated circuit die and/or the multiple dies in a single chip package may contain a plurality of other elements of the computing device 300, for example, but not limited to, the clock 310, the bus 330, the memory 340, and I/O 360.

The CPU 320 may contain cache 322 such as but not limited to a level 1 cache, a level 2 cache, a level 3 cache, or combinations thereof. The cache 322 may or may not be shared amongst a plurality of CPU cores 321. The cache 322 sharing may comprise at least one of message passing and inter-core communication methods used for the at least one CPU Core 321 to communicate with the cache 322. The inter-core communication methods may comprise, but not be limited to, bus, ring, two-dimensional mesh, and crossbar. The aforementioned CPU 320 may employ symmetric multiprocessing (SMP) design.

The one or more CPU cores 321 may comprise soft microprocessor cores on a single field programmable gate array (FPGA), such as semiconductor intellectual property cores (IP Core). The architectures of the one or more CPU cores 321 may be based on at least one of, but not limited to, Complex Instruction Set Computing (CISC), Zero Instruction Set Computing (ZISC), and Reduced Instruction Set Computing (RISC). At least one performance-enhancing method may be employed by one or more of the CPU cores 321, for example, but not limited to Instruction-level parallelism (ILP) such as, but not limited to, superscalar pipelining, and Thread-level parallelism (TLP).

Consistent with the embodiments of the present disclosure, the aforementioned computing device 300 may employ a communication system that transfers data between components inside the computing device 300, and/or the plurality of computing devices 300. The aforementioned communication system will be known to a person having ordinary skill in the art as a bus 330. The bus 330 may embody internal and/or external hardware and software components, for example, but not limited to a wire, an optical fiber, various communication protocols, and/or any physical arrangement that provides the same logical function as a parallel electrical bus. The bus 330 may comprise at least one of a parallel bus, wherein the parallel bus carries data words in parallel on multiple wires; and a serial bus, wherein the serial bus carries data in bit-wise serial form. The bus 330 may embody a plurality of topologies, for example, but not limited to, a multidrop/electrical parallel topology, a daisy chain topology, and connected by switched hubs, such as a USB bus. The bus 330 may comprise a plurality of embodiments, for example, but not limited to:
Internal data bus (data bus) 331/Memory bus
Control bus 332
Address bus 333
System Management Bus (SMBus)
Front-Side-Bus (FSB)
External Bus Interface (EBI)
Local bus
Expansion bus
Lightning bus
Controller Area Network (CAN bus)
Camera Link
ExpressCard
Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.
Small Computer System Interface (SCSI)/Serial Attached SCSI (SAS)
HyperTransport
InfiniBand
RapidIO
Mobile Industry Processor Interface (MIPI)
Coherent Processor Interface (CAPI)
Plug-n-play
1-Wire
Peripheral Component Interconnect (PCI), including embodiments such as but not limited to, Accelerated Graphics Port (AGP), Peripheral Component Interconnect extended (PCI-X), Peripheral Component Interconnect Express (PCI-e) (e.g., PCI Express Mini Card, PCI Express M.2 [Mini PCIe v2], PCI Express External Cabling [ePCIe], and PCI Express OCuLink [Optical Copper{Cu} Link]), Express Card, AdvancedTCA, AMC, Universal IO, Thunderbolt/Mini DisplayPort, Mobile PCIe (M-PCIe), U.2, and Non-Volatile Memory Express (NVMe)/Non-Volatile Memory Host Controller Interface Specification (NVMHCIS).
Industry Standard Architecture (ISA), including embodiments such as, but not limited to Extended ISA (EISA), PC/XT-bus/PC/AT-bus/PC/104 bus (e.g., PC/104-Plus, PCI/104-Express, PCI/104, and PCI-104), and Low Pin Count (LPC).
Music Instrument Digital Interface (MIDI)
Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 1394 Interface/Firewire, Thunderbolt, and extensible Host Controller Interface (xHCI).

Consistent with the embodiments of the present disclosure, the aforementioned computing device 300 may employ hardware integrated circuits that store information for immediate use in the computing device 300, known to persons having ordinary skill in the art as primary storage or memory 340. The memory 340 operates at high speed, distinguishing it from the non-volatile storage sub-module 361, which may be referred to as secondary or tertiary storage, which provides relatively slower-access to information but offers higher storage capacity. The data contained in memory 340 may be transferred to secondary storage via techniques such as, but not limited to, virtual memory and swap. The memory 340 may be associated with addressable semiconductor memory, such as integrated circuits consisting of silicon-based transistors, that may be used as primary storage or for other purposes in the computing device 300. The memory 340 may comprise a plurality of embodiments, such as, but not limited to volatile memory, non-volatile memory, and semi-volatile memory. It should be understood by a person having ordinary skill in the art that the following are non-limiting examples of the aforementioned memory:
Volatile memory, which requires power to maintain stored information, for example, but not limited to, Dynamic Random-Access Memory (DRAM) 341, Static Random-Access Memory (SRAM) 342, CPU Cache memory 325, Advanced Random-Access Memory (A-RAM), and other types of primary storage such as Random-Access Memory (RAM).
Non-volatile memory, which can retain stored information even after power is removed, for example, but not limited to, Read-Only Memory (ROM) 343, Programmable ROM (PROM) 344, Erasable PROM (EPROM) 345, Electrically Erasable PROM (EEPROM) 346 (e.g., flash memory and Electrically Alterable PROM [EAPROM]), Mask ROM (MROM), One Time Programmable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory may have limited non-volatile duration after power is removed but may lose data after said duration has passed. Semi-volatile memory provides high performance, durability, and other valuable characteristics typically associated with volatile memory, while providing some benefits of true non-volatile memory. The semi-volatile memory may comprise volatile and non-volatile memory, and/or volatile memory with a battery to provide power after power is removed. The semi-volatile memory may comprise, but is not limited to, spin-transfer torque RAM (STT-RAM).

Consistent with the embodiments of the present disclosure, the aforementioned computing device 300 may employ a communication system between an information processing system, such as the computing device 300, and the outside world, for example, but not limited to, human, environment, and another computing device 300. The aforementioned communication system may be known to a person having ordinary skill in the art as an Input/Output (I/O) module 360. The I/O module 360 regulates a plurality of inputs and outputs with regard to the computing device 300, wherein the inputs are a plurality of signals and data received by the computing device 300, and the outputs are the plurality of signals and data sent from the computing device 300. The I/O module 360 interfaces with a plurality of hardware, such as, but not limited to, non-volatile storage 361, communication devices 362, sensors 363, and peripherals 364. The plurality of hardware is used by at least one of, but not limited to, humans, the environment, and another computing device 300 to communicate with the present computing device 300. The I/O module 360 may comprise a plurality of forms, for example, but not limited to channel I/O, port mapped I/O, asynchronous I/O, and Direct Memory Access (DMA).

Consistent with the embodiments of the present disclosure, the aforementioned computing device 300 may employ a non-volatile storage sub-module 361, which may be referred to by a person having ordinary skill in the art as one of secondary storage, external memory, tertiary storage, off-line storage, and auxiliary storage. The non-volatile storage sub-module 361 may not be accessed directly by the CPU 320 without using an intermediate area in the memory 340. The non-volatile storage sub-module 361 may not lose data when power is removed and may be orders of magnitude less costly than storage used in memory 340. Further, the non-volatile storage sub-module 361 may have a slower speed and higher latency than in other areas of the computing device 300. The non-volatile storage sub-module 361 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (361) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD+RW/DVD±RW/DVD+R DL/DVD-RAM/HD-DVD), Blu-ray Disk (BD) (BD-ROM/BD-R/BD-RE/BD-R DL/BD-RE DL), and Ultra-Density Optical (UDO).
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor.
Magnetic storage such as, but not limited to, Hard Disk Drive (HDD), tape drive, carousel memory, and Card Random-Access Memory (CRAM).
Phase-change memory
Holographic data storage such as Holographic Versatile Disk (HVD).
Molecular Memory
Deoxyribonucleic Acid (DNA) digital data storage

Consistent with the embodiments of the present disclosure, the computing device 300 may employ a communication sub-module 362 as a subset of the I/O module 360, which may be referred to by a person having ordinary skill in the art as at least one of, but not limited to, a computer network, a data network, and a network. The network may allow computing devices 300 to exchange data using connections, which may also be known to a person having ordinary skill in the art as data links, which may include data links between network nodes. The nodes may comprise networked computer devices 300 that may be configured to originate, route, and/or terminate data. The nodes may be identified by network addresses and may include a plurality of hosts consistent with the embodiments of a computing device 300. Examples of computing devices that may include a communication sub-module 362 include, but are not limited to, personal computers, phones, servers, drones, and networking devices such as, but not limited to, hubs, switches, routers, modems, and firewalls.

Two nodes can be considered networked together when one computing device 300 can exchange information with the other computing device 300, regardless of any direct connection between the two computing devices 300. The communication sub-module 362 supports a plurality of applications and services, such as, but not limited to World Wide Web (WWW), digital video and audio, shared use of application and storage computing devices 300, printers/scanners/fax machines, email/online chat/instant messaging, remote control, distributed computing, etc. The network may comprise one or more transmission mediums, such as, but not limited to conductive wire, fiber optics, and wireless signals. The network may comprise one or more communications protocols to organize network traffic, wherein application-specific communications protocols may be layered, and may be known to a person having ordinary skill in the art as being improved for carrying a specific type of payload, when compared with other more general communications protocols. The plurality of communications protocols may comprise, but are not limited to, IEEE 802, ethernet, Wireless LAN (WLAN/Wi-Fi), Internet Protocol (IP) suite (e.g., TCP/IP, UDP, Internet Protocol version 4 [IPv4], and Internet Protocol version 6 [IPv6]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], Integrated Digital Enhanced Network [IDEN], Long Term Evolution [LTE], LTE-Advanced [LTE-A], and fifth generation [5G] communication protocols).

The communication sub-module 362 may comprise a plurality of size, topology, traffic control mechanisms and organizational intent policies. The communication sub-module 362 may comprise a plurality of embodiments, such as, but not limited to:
Wired communications, such as, but not limited to, coaxial cable, phone lines, twisted pair cables (ethernet), and InfiniBand.
Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Wherein cellular systems embody technologies such as, but not limited to, 3G,4G (such as WiMAX and LTE), and 5G (short and long wavelength).
Parallel communications, such as, but not limited to, LPT ports.
Serial communications, such as, but not limited to, RS-232 and USB.
Fiber Optic communications, such as, but not limited to, Single-mode optical fiber (SMF) and Multi-mode optical fiber (MMF).
Power Line communications

The aforementioned network may comprise a plurality of layouts, such as, but not limited to, bus networks such as Ethernet, star networks such as Wi-Fi, ring networks, mesh networks, fully connected networks, and tree networks. The network can be characterized by its physical capacity or its organizational purpose. Use of the network, including user authorization and access rights, may differ according to the layout of the network. The characterization may include, but is not limited to a nanoscale network, a Personal Area Network (PAN), a Local Area Network (LAN), a Home Area Network (HAN), a Storage Area Network (SAN), a Campus Area Network (CAN), a backbone network, a Metropolitan Area Network (MAN), a Wide Area Network (WAN), an enterprise private network, a Virtual Private Network (VPN), and a Global Area Network (GAN).

Consistent with the embodiments of the present disclosure, the aforementioned computing device 300 may employ a sensors sub-module 363 as a subset of the I/O 360. The sensors sub-module 363 comprises at least one of the device, module, or subsystem whose purpose is to detect events or changes in its environment and send the information to the computing device 300. Sensors may be sensitive to the property they are configured to measure, may not be sensitive to any property not measured but be encountered in its application, and may not significantly influence the measured property. The sensors sub-module 363 may comprise a plurality of digital devices and analog devices, wherein if an analog device is used, an Analog to Digital (A-to-D) converter must be employed to interface the said device with the computing device 300. The sensors may be subject to a plurality of deviations that limit sensor accuracy. The sensors sub-module 363 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:
Chemical sensors, such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nanosensors).
Automotive sensors, such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel/oil level sensor, knock sensor, light sensor, MAP sensor, oxygen sensor (o2), parking sensor, radar sensor, torque sensor, variable reluctance sensor, and water-in-fuel sensor.
Acoustic, sound and vibration sensors, such as, but not limited to, microphone, lace sensors such as a guitar pickup, seismometer, sound locator, geophone, and hydrophone.
Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.
Environmental, weather, moisture, and humidity sensors, such as, but not limited to, actinometer, air pollution sensor, moisture alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.
Flow and fluid velocity sensors, such as, but not limited to, air flow meter, anemometer, flow sensor, gas meter, mass flow sensor, and water meter.
Ionizing radiation and particle sensors, such as, but not limited to, cloud chamber, Geiger counter, Geiger-Muller tube, ionization chamber, neutron detection, proportional counter, scintillation counter, semiconductor detector, and thermoluminescent dosimeter.
Navigation sensors, such as, but not limited to, airspeed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.
Position, angle, displacement, distance, speed, and acceleration sensors, such as but not limited to, accelerometer, displacement sensor, flex sensor, free-fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver.
Imaging, optical and light sensors, such as, but not limited to, CMOS sensor, colorimeter, contact image sensor, electro-optical sensor, infra-red sensor, kinetic inductance detector, LED configured as a light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photoswitch, phototube, scintillometer, Shack-Hartmann, single-photon avalanche diode, superconducting nanowire single-photon detector, transition edge sensor, visible light photon counter, and wavefront sensor.
Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.
Force, Density, and Level sensors, such as, but not limited to, bhangmeter, hydrometer, force gauge or force sensor, level sensor, load cell, magnetic level or nuclear density sensor or strain gauge, piezocapacitive pressure sensor, piezoelectric sensor, torque sensor, and viscometer.
Thermal and temperature sensors, such as, but not limited to, bolometer, bimetallic strip, calorimeter, exhaust gas temperature gauge, flame detection/pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.
Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 300 may employ a peripherals sub-module 364 as a subset of the I/O 360. The peripheral sub-module 364 comprises ancillary devices uses to put information into and get information out of the computing device 300. There are 3 categories of devices comprising the peripheral sub-module 364, which exist based on their relationship with the computing device 300, input devices, output devices, and input/output devices. Input devices send at least one of data and instructions to the computing device 300. Input devices can be categorized based on, but not limited to:
Modality of input, such as, but not limited to, mechanical motion, audio, visual, and tactile.
Whether the input is discrete, such as but not limited to, pressing a key, or continuous such as, but not limited to the position of a mouse.
The number of degrees of freedom involved, such as, but not limited to, two-dimensional mice and three-dimensional mice used for Computer-Aided Design (CAD) applications.

Output devices provide output from the computing device 300. Output devices convert electronically generated information into a form that can be presented to humans. Input/output devices perform that perform both input and output functions. It should be understood by a person having ordinary skill in the art that the ensuing are non-limiting embodiments of the aforementioned peripheral sub-module 364:
Input Devices
   Human Interface Devices (HID), such as, but not limited to, pointing device (e.g., mouse, touchpad, joystick, touchscreen, game controller/gamepad, remote, light pen, light gun, infrared remote, jog dial, shuttle, and knob), keyboard, graphics tablet, digital pen, gesture recognition devices, magnetic ink character recognition, Sip-and-Puff (SNP) device, and Language Acquisition Device (LAD).
   High degree of freedom devices, that require up to six degrees of freedom such as, but not limited to, camera gimbals, Cave Automatic Virtual Environment (CAVE), and virtual reality systems.
   Video Input devices are used to digitize images or video from the outside world into the computing device 300. The information can be stored in a multitude of formats depending on the user's requirement. Examples of types of video input devices include, but are not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
   Audio input devices are used to capture sound. In some cases, an audio output device can be used as an input device to capture produced sound. Audio input devices allow a user to send audio signals to the computing device 300 for at least one of processing, recording, and carrying out commands. Devices such as microphones allow users to speak to the computer to record a voice message or navigate software. Aside from recording, audio input devices are also used with speech recognition software. Examples of types of audio input devices include, but not limited to microphone, Musical Instrumental Digital Interface (MIDI) devices such as, but not limited to a keyboard, and headset.
   Data AcQuisition (DAQ) devices convert at least one of analog signals and physical parameters to digital values for processing by the computing device 300. Examples of DAQ devices may include, but not limited to, Analog to Digital Converter (ADC), data logger, signal conditioning circuitry, multiplexer, and Time to Digital Converter (TDC).
Output Devices may further comprise, but not be limited to:
   Display devices may convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).
   Printers, such as, but not limited to, inkjet printers, laser printers, 3D printers, solid ink printers, and plotters.
   Audio and Video (AV) devices, such as, but not limited to, speakers, headphones, amplifiers, and lights, which include lamps, strobes, DJ lighting, stage lighting, architectural lighting, special effect lighting, and lasers.
   Other devices such as Digital to Analog Converter (DAC)
Input/Output Devices may further comprise, but not be limited to, touchscreens, networking devices (e.g., devices disclosed in network sub-module 362), data storage devices (non-volatile storage 361), facsimile (FAX), and graphics/sound cards.

All rights, including copyrights in the code included herein, are vested in and the property of the Applicant. The Applicant retains and reserves all rights in the code included herein, and grants permission to reproduce the material only in connection with the reproduction of the granted patent and for no other purpose.

The following is claimed:

1. A method for managing a hive-based carpool system, comprising:
establishing, by a server, a plurality of households, wherein each household comprises at least one ride provider user and at least one ride recipient user;
establishing, by the server, a hive, wherein the hive represents a communication channel for a group of users, wherein each group of users comprises at least one ride recipient user, and all ride provider users in the same household as the at least one ride recipient user;
affiliating each ride provider user in the hive with at least one ride recipient user in the hive;
receiving, from a user of the group of users in the hive, a ride request, wherein the ride request comprises a pickup location, a drop-off location, and a time;
transmitting the ride request to authorized drivers from among the ride provider users in the hive;
receiving an acceptance of the ride request from a particular authorized driver; and
updating ride status in real-time for at least one other member of the hive.

2. The method of claim 1, wherein the communication channel comprises a messaging interface that enables real-time chat functionality between members of the communication channel.

3. The method of claim 1, wherein the ride recipient users comprise minor users, and wherein the ride provider users comprise adults affiliated with at least one of the minors.

4. The method of claim 1, wherein the communication channel restricts membership in the hive to permit a ride provider user only while the ride provider user is authorized to provide rides to at least one ride recipient user in the hive.

5. The method of claim 1, wherein each ride recipient user is able to invite additional ride recipient users to join the hive, and wherein addition of a new ride recipient user to the hive results in addition of at least one ride provider user associated with the new ride recipient user to the hive.

6. The method of claim 1, wherein each ride provider user is able to invite additional ride provider users and affiliated ride recipient users to join the hive.

7. The method of claim 1, further comprising:
tracking location of the particular authorized driver during provision of the ride, wherein tracking location of the particular authorized driver comprises real-time location tracking of the particular authorized driver and one or more ride recipient users during the ride.

8. A system for facilitating hive-based carpools, comprising:
a database storing user profiles categorized as ride recipient users or ride provider users;
a hive management module configured to:
create a plurality of households, wherein each household comprises at least one ride provider user;
create a hive representing a communication channel for a group of users, the group comprising a plurality of ride provider users, and
control membership in the hive based on user category and affiliations;
a ride request module configured to:
receive a ride request from a user in the hive, the ride request representing one or more ride recipients, and
transmit the ride request to one or more ride provider users in the hive; and
a notification module configured to provide ride status updates to one or more members of the hive.

9. The system of claim 8, wherein the communication channel comprises a messaging interface that enables real-time chat functionality between members of the communication channel.

10. The system of claim 8, wherein the hive comprises one or more ride recipient users, wherein at least one of the one or more ride recipient users is a minor, and wherein the ride provider users comprise adults affiliated with at least one of the minors.

11. The system of claim 10, wherein the communication channel restricts membership of ride provider users to only users who are authorized to give rides to at least one of the ride recipient users.

12. The system of claim 10, wherein the system enables each of the ride recipient users to invite additional ride recipient users to the hive, and wherein addition of a new ride recipient user causes addition of at least one ride provider user affiliated with the new ride recipient user to the hive.

13. The system of claim 8, wherein the system enables each ride provider user to invite additional ride provider users and affiliated ride recipient users to join the hive.

14. The system of claim 8, further comprising:
a tracking module configured to monitor real-time location of vehicles providing rides, wherein the tracking module performs real-time location tracking of an authorized driver and one or more ride recipient users during the ride.

15. A non-transitory computer-readable medium storing instructions that, when executed by a processor, cause the processor to perform operations comprising:
establishing, by a server, a plurality of households, wherein each household comprises at least one ride provider user;
establishing, by the server, a hive, wherein each hive represents a communication channel for a group of users, wherein each group of users comprises a plurality of ride provider users;
receiving, from a user in the hive, a ride request, wherein the ride request comprises a pickup location, a drop-off location, and a time;
transmitting the ride request to authorized drivers from among the ride provider users in the hive;
receiving an acceptance of the ride request from a particular authorized driver; and
updating ride status in real-time for at least one other member of the hive.

16. The non-transitory computer-readable medium of claim 15, wherein the communication channel comprises a messaging interface that enables real-time chat functionality between members of the communication channel.

17. The non-transitory computer-readable medium of claim 15, wherein the hive further comprises one or more ride recipient users, wherein at least one of the ride recipient users is a minor, and wherein the ride provider users comprise adults affiliated with at least one of the minors.

18. The non-transitory computer-readable medium of claim 17, wherein the communication channel restricts membership of ride provider users in the hive to only ride provider users who are authorized to give rides to at least one ride recipient user in the hive.

19. The non-transitory computer-readable medium of claim 17, wherein each of the ride recipient users is able to invite additional ride recipient users to the hive, and wherein addition of a new ride recipient user causes addition of an affiliated ride provider user to the hive.

20. The non-transitory computer-readable medium of claim 15, wherein each ride provider user is able to invite additional ride provider users and affiliated ride recipient users to join the communication channel.
